(19) United States
(12) Patent Application Publication
(10) Pub. No.: US 2007/0142516 A1
(43) Pub. Date: Jun. 21, 2007

(54) Adhesive composition, method of pre-treating a support film, and polarizing sheet comprising the same

(76) Inventor: Kang-Wei Wei, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/558,931

(22) Filed: Nov. 12, 2006

(30) Foreign Application Priority Data
Dec. 21, 2005 (TW) 094145611

(51) Int. Cl. B60C 1/00

(52) U.S. Cl. 524/261; 524/557

(57) ABSTRACT

The present invention relates a adhesive composition, which comprising from 50 to 99 weight parts of water-based solvent, from 0.5 to 10 weight parts of polyvinyl alcohol, and from 0.01 to 2 weight parts of R¹Si(OR²)₃, wherein R¹ is a hydrocarbonyl group having a cross-linking functional group and R²s are same or different and each is a hydrogen atom or hydrocarbonyl group. A pre-treatment method for support film is also related, wherein the support film is endowed with —Si—O— groups and can be used to manufacture polarizing sheets with the adhesive composition together.

### BACKGROUND OF THE INVENTION

1. Field of the Invention

The present invention relates to an adhesive composition, and particularly to an adhesive composition used in a polarizing sheet manufacturing process, a pre-treatment of a support film, and a polarizing sheet using the adhesive composition.

2. Description of the Prior Art

Polarizing sheets are often disposed on the surface of glass substrates of liquid crystal display (LCD) devices. Generally, the polarizing sheets are mainly categorized into an iodine-type and a dyestuff type, for example, comprising polyvinyl alcohol (PVA) film dyed with iodine or a dichroic dye.

FIG. 1 is a schematic, cross-sectional diagram demonstrating a conventional polarizing sheet 10. Typically, the polarizing sheet 10 includes an adhesive release film 12, a pressure-sensitive adhesive 14, a polyvinyl alcohol (PVA) film 18 sandwiched between triacetyl cellulose (TAC) support films 16 and 20, and a protective film 22 laminated on the TAC film 20. In other cases, an anti-glare coating, an anti-reflection coating or a hard-coating film may be employed on the TAC film 20. The iodine-type polarizing sheet is more prevalent in the industry than other types because of its high optical performance, such as high transmittance, high contrast ratio, and a wide range for applicable wavelength, easiness to make, and cheapness.

Generally, an iodine-type polarizing sheet is produced by lamination of TAC films 16 and 20 on both sides of the PVA film 18. Prior to the lamination, the PVA film 18 undergoes pre-treatment such as swelling with water, dyeing by dipped with iodine, and re-stretching. The pre-treated PVA film 18 is laminated with the TAC films 16 and 20, which are also pre-treated by an alkaline solution such as a sodium hydroxide or potassium hydroxide solution, by applying previously prepared adhesive containing dissolved PVA powders and a cross-linking agent therein. After dried, the TAC film 20 is further laminated with a protection film 22 for prevention from surface scratch and then TAC film 16 is laminated with a pressure-sensitive adhesive 14 on a release film 12, to form a polarizing sheet. As shown in FIG. 2, PVA film 18 adheres to TAC films 16 and 20 by hydrogen bonding generated by each and an adhesive layer 24 disposed therebetween. However, the conventional adhesion has a poor water tolerance and a poor heat resistance.

Since the polarizing sheets comprising conventional iodine-type polarizing film is not resistant to high temperature and high moisture, they are not suitable for some specific LCD devices, such as those used in aircrafts, marine crafts, and vehicles and large size outdoor LCD devices. Accordingly, expensive dichroic polymeric polarizing films are generally used instead.

Therefore, it is needed to develop a novel polarizing sheet with good water tolerance, especially those comprising iodine type polarizing films.

### SUMMARY OF THE INVENTION

An object of the present invention is to provide an adhesive composition able to effectively attach a polarizing film to a support film in a polarizing sheet and having excellent properties of water tolerance and heat resistance.

Another object of the present invention is to provide a method of pre-treating a support film. The pre-treated support film can be effectively adhered to a polarizing film with the adhesive composition according to the present invention to form a polarizing sheet with excellent properties of water tolerance and heat resistance.

According to the present invention, the adhesive composition comprises from 50 to 99 weight parts of an aqueous solvent; from 0.5 to 10 weight parts of a polyvinyl alcohol; and from 0.01 to 2 weight parts of R¹Si(OR²)₃ and a derivative thereof, wherein R¹ is a hydrocarbonyl group having a cross-linking functional group and R²s are same or different and each is a hydrogen atom or a hydrocarbonyl group.

According to the present invention, the method of pre-treating a support film comprises steps as follows. First, saponification is performed on a support film in a solution of a strong alkali at 40 to 70° C. Next, the support film is placed in a solution of a silicate or a related silicon-containing derivative thereof at 10 to 90° C. to react and form a silicon-oxygen bonding on a surface of the support film. Finally, the solvent in the solution on the support film is removed.

An adhered stacking sheet or a polarizing sheet may be further formed according to embodiments of the adhesive composition or the pre-treatment method of the support film of the present invention, which are also in the scope of the present invention.

The term “polarizing film” herein refers to as a film or layer having a function of polarization among all layers of a polarizing sheet. For example, a polarizing film contains iodine or dichroic dyestuffs.

It is advantageous to manufacture polarizing sheets according to the present invention that the amount of polyvinyl alcohol powder used as a conventional water-dispersed adhesive is reduced, the water tolerance of the polarizing sheet manufactured is increased, the pre-treatment is not difficult, and the contact angle of the support film is the same as that of a support film after a conventional pre-treatment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic, cross-sectional diagram demonstrating a conventional polarizing sheet;

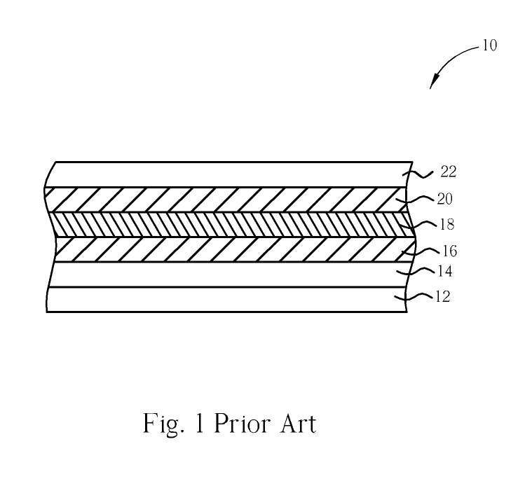

FIG. 2 is a schematic diagram showing a PVA film and a TAC film adhering to each other through an adhesive layer therebetween in a prior art;

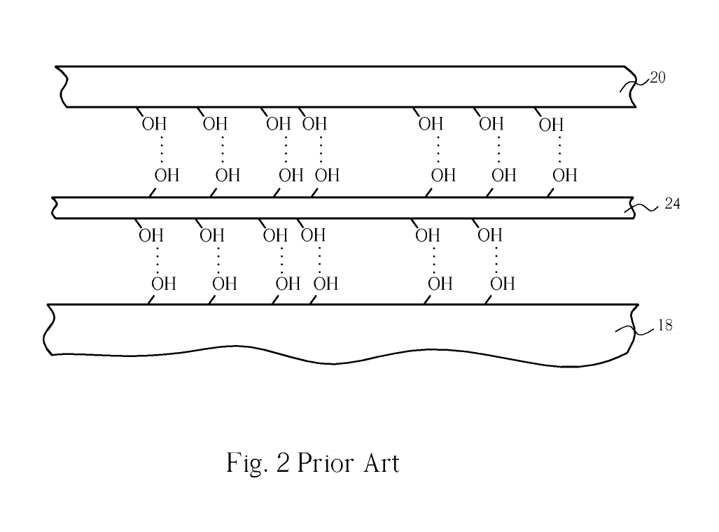

FIG. 3 is a schematic flow chart showing an embodiment of the method of pre-treating a support film according to the present invention;

FIG. 4 is a schematic diagram showing a network silicon-oxygen covalent bonding formed from a silanol (R¹Si(OH)₃) and silicon-oxide bonds on the surface of the pretreated TAC film according to the present invention;

FIG. 5 is a schematic diagram showing the adhesion of the PVA film and the TAC film after saponification and surface modification to the adhesive composition according to the present invention respectively by bonding to each other; and

FIG. 6 is a schematic flow chart showing the manufacturing of polarizing sheets using the adhesive composition by the method of pre-treating a support film according to the present invention.

### DETAILED DESCRIPTION

The adhesive composition according to the present invention comprises from about 50 to about 99 weight parts of an aqueous solvent, from about 0.5 to about 10 weight parts of polyvinyl alcohol, and from about 0.01 to about 2 weight parts of R¹Si(OR²)₃ or a silicon-containing derivative thereof, wherein R¹ is a hydrocarbonyl group having a cross-linking functional group and R²s are same or different and each is a hydrogen atom or a hydrocarbonyl group. Accordingly, the adhesive composition of the present invention is characterized by a silicon-containing component.

The adhesive composition of the present invention is water dispersible and uses an aqueous solvent, for example, the water, alcohols, or the like.

Polyvinyl alcohol (PVA) used in the present invention may be those used in conventional water dispersible adhesives, for example, the polyvinyl alcohol with a weight average molecular weight of about 50,000 to about 150,000, and preferably, about 70,000 to about 110,000. The polyvinyl alcohol may be a raw material in a powder form and be dissolved in the aqueous solvent upon manufacturing the adhesive composition of the present invention.

R¹Si(OR²)₃ used is a tri(alkoxyl)silane. R¹ represents a hydrocarbonyl group having a cross-linking functional group. The hydrocarbonyl group may be, for example, preferably an alkyl group, an alkenyl group, or an alkynyl group having 2 to 4 carbon atoms. The cross-linking functional group may be, for example, an epoxy group, a vinyl group, a methacrylic group, an amino group, or a halo group (such as a chloro, iodo, or bromo group). R²s are same or different and may be a hydrogen atom or a hydrocarbonyl group, for example, an alkyl group having 1 to 4 carbon atoms, an alkenyl or alkynyl group having 2 to 4 carbon atoms. The hydrocarbonyl group useful is not limited to the number of carbon atoms, and no matter commercially obtained or made, as long as the length of the carbon chain does not generate non-useful properties to the adhesive layer. A related silicon-containing derivative of R¹Si(OR²)₃ may be used instead of or combined with R¹Si(OR²)₃.

The adhesive composition according to the present invention may be utilized as an adhesive to stick a polarizing film to a support film in the manufacturing process of polarizing sheets. It is noted that the support film is preferably pre-treated by saponification to modify the surface before it is adhered to the polarizing film utilizing the adhesive composition according to the present invention, to achieving a more effective adhesion. The polarizing film may be, for example, an iodine-type PVA polarizing film or a dichroic polymeric polarizing film. The support film may be, for example, a TAC film.

In the present invention, when a TAC film is used as a support film, saponification approximately the same as the conventional TAC saponification is performed in the pretreatment process. However, in the conventional TAC saponification, an alkaline solution, such as a sodium hydroxide or potassium hydroxide solution, is used for imparting hydroxyl groups on the surface of the TAC film, and the surface of TAC becomes hydrophilic to facilitate the adhesion of the TAC film to the dip dyed and stretched PVA film through a PVA hydrogel. In the present invention, the surface of the TAC support film, after subjective to the saponification with a strong alkali, is further modified in a solution containing silicate. The silicate used may be for example sodium silicate (also known as water glass) or potassium silicate. Water glass is usually in a form of silicon dioxide (SiO₂) dissolved in a concentrated sodium hydroxide solution.

The temperature for the saponification may be between 40 and 70° C., and the temperature for the reaction with silicate may be between 10 and 90° C.

If the concentration of the silicate is too high, the silicate precipitates naturally. If the concentration is too low, only a limited area of the surface of the support film acquires the modification. The concentration is preferably in the range of 0.1 to 3 weight percent, and more preferably 1 weight percent, based on the weight of the treating solution as 100 weight percent.

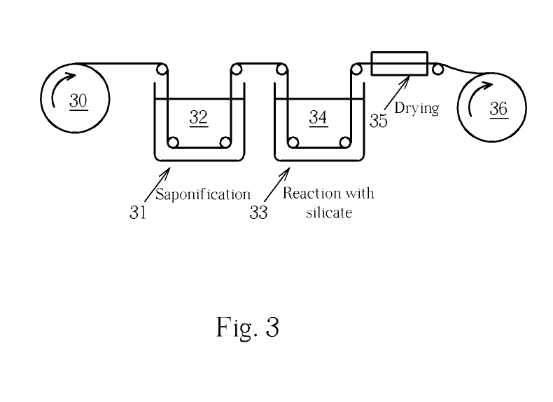

Please refer to FIG. 3 showing a schematic flow chart for pre-treating a support film according to the present invention. A support film 30 is placed in a strong alkaline solution 32 and subject to saponification in a step 31, and thereafter the support film 30 is placed in a silicate solution 34 for allowing the surface to react with the silicate in a step 33. Finally, the solvent is removed for dryness in a step 35, and a silicon-containing saponified support film 36 is manufactured.

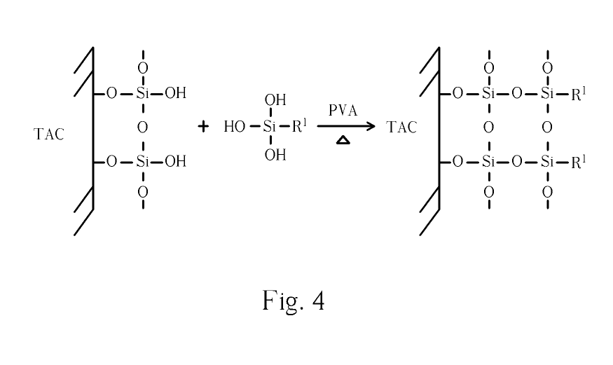

FIG. 3 shows that a strong alkaline solution and a silicate solution used are located in different reaction tanks. Nevertheless, the reaction of the surface of the support film and the silicate preferably takes place at the same time that the saponification in a strong alkali is performed, and thus the strong alkaline solution and the silicate solution used may exist together in a same reaction tank, to form silicon-oxygen bonding on the surface of the support film for the following adhesion process, as shown by the TAC film surface located at left side of the arrow sign in FIG. 4.

The steps for the adhesion of the polarizing film (such as PVA film) and the support film (TAC film) with the adhesive composition according to the present invention as an adhesive is as follows.

First, the adhesive composition according to the present invention is formed through steps as follows. First, a polyvinyl alcohol powder is dissolved in water and tri(alkoxyl)silane (R¹Si(OR²)₃) is added. Next, additives such as a cross-linking agent in an amount of about 0.01 to 2 weight percent is added at room temperature and the resulting solution is regulated to be slight acidic, for example, in a pH value of about 2 to 5, and preferably about 3.5 to 4.5, by, for example, an addition of hydrochloric acid. In a slightly acidic environment, tri(alkoxyl)silane is hydrolyzed to form a silanol as shown by the chemical equation (I) as follows.

R¹Si(OR²)₃+H₂O→R¹Si(OH)₃+3R²OH (I)

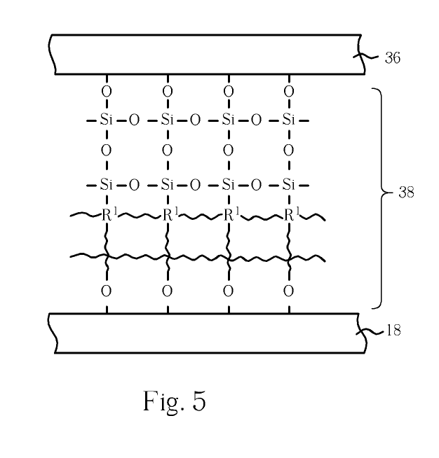

Thereafter, the pre-treated support film (such as TAC film) is attached to the polarizing film (such as dyed and stretched PVA film) using the adhesive composition according to the present invention. Since the pre-treated TAC film has silicon-oxygen bonds on the surface, they are allowed to react with silanol (R¹Si(OH)₃) to form network silicon-oxygen covalent bonds, as shown by the TAC film surface pointed by the arrow sign in FIG. 4. The adhesion of the TAC film to the PVA film is further enhanced by the function of a small amount of a PVA hydrogel and a cross-linking agent added in the adhesive composition and the cross-linking functional groups on R¹ groups, to improve water tolerance and heat resistance. A part of the stacked structure is schematically shown in FIG. 5. The adhesion of the PVA film 18 to the silicon-containing saponified TAC film 36 is accomplished through the bonding of both to the adhesive layer 38, respectively.

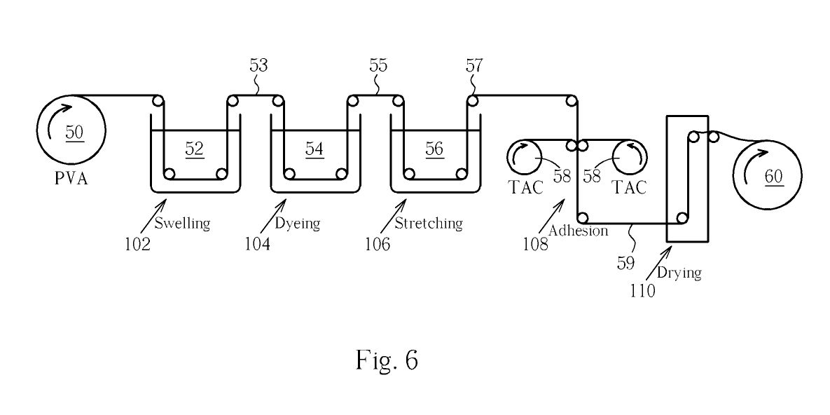

Referring to FIG. 6, the manufacturing of polarizing sheets using the adhesive composition according to the present invention and the method of pre-treating a support film according to the present invention is described. First, an un-stretched PVA film 50 is dipped in pure water 52 to perform a step 102 for swelling. The un-stretched PVA film 50 may be commercially obtained from Kuraray Company.

A step 104 for dyeing is performed after the PVA film 53 is swelled. The PVA film 53 is dipped in an iodine-containing solution formulation 54 to adsorb iodine. The iodine-containing solution formulation 54 contains iodine molecules and potassium iodide, and the total iodine is in a concentration of about 0.01 to 0.5 weight %.

Thereafter, the step 106 for stretching is performed on the dip dyed PVA film 55, that is, a stretching process for the PVA film. Generally, the PVA film 55 is uniaxially stretched in a cross-linking agent formulation 56 containing boric acid and potassium iodide. Boric acid is in a concentration of about 1 weight % to about 10 weight %. According to a preferred embodiment of the present invention, the total stretching ratio of the PVA film is about 4 to 7.

Next, a step 108 for lamination is performed to laminate the stretched PVA film 57 with the TAC film 58 pre-treated by silicate and strong alkali through the adhesive composition according to the present invention, to form a three-layered film structure (TAC-PVA-TAC).

Finally, a step 110 for dryness is performed on the three-layered film structure (TAC-PVA-TAC) 59 by drying at, for example, 80° C., to form a polarizing sheet 60.

Furthermore, the TAC film may be coated with a liquid crystal alignment layer, a protection layer, an anti-glare layer, an anti-reflection layer, a scratch prevention layer, or an anti-smudge layer to improve the performance of the polarizing sheet.

Some examples are described hereinafter to detail the manufacturing of the adhesive composition and the usage of the same in polarizing sheets according to the present invention. Each component in the composition may be prepared using general processes or obtained commercially.

### EXAMPLE

### Example 1

A sodium silicate aqueous solution was added to a 10 weight % of sodium hydroxide solution and the resulting concentration of sodium silicate was 1 weight %, to obtain a pre-treating solution. A TAC film was placed in the pre-treating solution at 50° C. for saponification, and then dried.

A water dispersible additive was formed by the steps as follows. First, a PVA powder having a weight average molecular weight of 50,000 to 110,000 was dissolved in water to make a concentration of 2.5 weight percent. Next, 3-glycidoxypropyltrimethoxysilane (made by Dow Corning company, product code: Z-6040) was added to make a concentration of 0.6 weight %. Then, a cross-linking agent was added at room temperature to make a concentration of 1.5 weight % and 0.1 N of hydrochloric acid is added to make a concentration of 1 weight %. The resulting solution was stirred for at least 15 minutes.

An adhesion process for making the polarizing sheet was performed by attaching the TAC film and a dip dyed and stretched PVA film to each other with the water dispersible adhesive described above, resulting a stack of TAC film-PVA film-TAC film, and the stack was dried at 80° C. to obtain a polarizing sheet.

### Example 2

A polarizing sheet was manufactured in the same method as described in Example 1, except that 3-methacryloxypropyltrimethoxysilane (manufactured by Dow Corning company, product code: Z-6030) was used instead of the product coded by Z-6040.

### Comparative Example 1

A TAC film was placed in a 10 weight % of sodium hydroxide solution as a pre-treating solution at 50° C. for saponification, and then dried.

A water dispersible additive was formed by the steps as follows. First, a PVA powder having a weight average molecular weight of 50,000 to 110,000 was dissolved in water to make a concentration of 2.5 weight percent. Next, 3-glycidoxypropyltrimethoxysilane (made by Dow Corning company, product code: Z-6040) was added to make a concentration of 0.6 weight %. Then, a cross-linking agent was added at room temperature to make a concentration of 1.5 weight % and 0.1 N of hydrochloric acid is added to make a concentration of 1 weight %. The resulting solution was stirred for at least 15 minutes.

An adhesion process for making the polarizing sheet was performed by attaching the TAC film and a dip dyed and stretched PVA film to each other with the water dispersible adhesive described above, resulting a stack of TAC film-PVA film-TAC film, and the stack was dried at 80° C.

### Comparative Example 2

A polarizing sheet was manufactured in the same method as described in Comparative Example 1, except that trimethoxysilane was not used and the amount of PVA powder was increased to make a concentration of 4.5 weight % for PVA in water.

A test of water tolerance was performed on the polarizing sheets obtained from Examples 1 and 2 and Comparative Examples 1 and 2 described above. The polarizing sheets were dipped in pure water at 50° C. and stripping situation was under observation. The result is shown in Table 1.

TABLE 1

| | Ex. 1 | Ex. 2 | Comp. Ex. 1 | Comp. Ex. 2 |
|---|---|---|---|---|
| Dipped in Water | >72 hrs | >72 hrs | 1 hr | 4 to 5 hrs |
| at 50° C. | | | | |
| Observation | O.K. | O.K. | stripped | slightly stripped |
| | | | | at edge |

In view of Table 1, stripping was not occur for the polarizing sheets obtained from Example 1 and 2 after dipping in water at 50° C. for 72 hours, and, contrarily, the polarizing sheets obtained from Comparative Example 1 and 2 showed a poor water tolerance. In Comparative Example 1, the pre-treatment of TAC film was not performed according to the present invention. In Comparative Example 2, the pre-treatment of TAC film was not performed according to the present invention and the adhesive composition according to the present invention was not used.

In comparison with conventional techniques, the silicon-containing water dispersible adhesive composition and the silicon related pre-treatment according to the present invention have the advantages described as follows.

1. The amount of polyvinyl alcohol powder is reduced relating to that in the conventional water dispersed adhesive. It is known from Comparative Example 2 that even though the amount of polyvinyl alcohol powder reached 4.5 weight percent, the effect is much inferior to Example 1 and 2.

2. In view of Comparative Example 1, the polarizing sheet has not an expected increased water tolerance, although the silicon containing water-dispersible adhesive was used, while the silicon-containing pre-treatment was not performed.

3. In the silicon-containing pre-treatment process, the sodium silicate aqueous solution is simply added into a conventional tank of strong alkali and accordingly the pre-treatment process will not be increased in difficulty.

4. The contact angle of the TAC film formed using the silicon-containing pre-treatment is the same as that of the TAC film formed using the conventional pre-treatment, and both are smaller than 20°.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adhesive composition, comprising:
from 50 to 99 weight parts of an aqueous solvent;
from 0.5 to 10 weight parts of a polyvinyl alcohol; and
from 0.01 to 2 weight parts of R¹Si(OR²)₃ and a derivative thereof, wherein R¹ is a hydrocarbonyl group having a cross-linking functional group and R²s are same or different and each is a hydrogen atom or a hydrocarbonyl group.

2. The adhesive composition as claimed in claim 1, wherein the aqueous solvent comprises water or an alcohol.

3. The adhesive composition as claimed in claim 1, wherein the cross-linking functional group comprises an epoxy group, a vinyl group, a methacrylic group, an amino group, or a halo group.

4. The adhesive composition as claimed in claim 1, further comprising from 0.01 to 2 weight parts of a cross-linking agent.

5. The adhesive composition as claimed in claim 1, further comprising an acid with an amount such that the adhesive composition has a pH of 2 to 5 while being utilized.

6. An adhesive sheet, comprising:
a sheet material, and
a layer of an adhesive composition formed on at least one surface of the sheet material, the adhesive composition comprising:
from 50 to 99 weight parts of an aqueous solvent;
from 0.5 to 10 weight parts of a polyvinyl alcohol; and
from 0.01 to 2 weight parts of R¹Si(OR²)₃ and a derivative thereof, wherein R¹ is a hydrocarbonyl group having a cross-linking functional group and R²s are same or different and each is a hydrogen atom or a hydrocarbonyl group.

7. A polarizing sheet, comprising:
an optical component sheet, and
a layer of an adhesive composition formed on at least one surface of the optical component sheet, the adhesive composition comprising:
from 50 to 99 weight parts of an aqueous solvent;
from 0.5 to 10 weight parts of a polyvinyl alcohol; and
from 0.01 to 2 weight parts of one selected from R¹Si(OR²)₃ and a derivative thereof, wherein R¹ is a hydrocarbonyl group having a cross-linking functional group and R²s are same or different and each is a hydrogen atom or a hydrocarbonyl group.

8. A method of pre-treating a support film, comprising:
performing saponification on a support film in a solution of a strong alkali at 40 to 70° C.;
placing the support film in a solution of a silicate or a derivative thereof at 10 to 90° C. to react and form a silicon-oxygen bonding on a surface of the support film; and
removing the solvent in the solution on the support film.

9. The method as claimed in claim 8, wherein the solution of a strong alkali and the solution of a silicate or a related silicon-containing derivative thereof are present in a same reaction tank.

10. The method as claimed in claim 8, wherein the saponification is performed in the solution of a strong alkaline in a first tank, and then the silicon-oxygen bonding is formed in the solution of a silicate or a derivative thereof in a second tank.

11. The method as claimed in claim 8, wherein the silicate comprises sodium silicate or potassium silicate.

12. The method as claimed in claim 8, wherein the strong alkali comprises sodium hydroxide or potassium hydroxide.

13. The method as claimed in claim 8, wherein the support film comprises a triacetyl cellulose (TAC) film.

14. A polarizing sheet, comprises:
a polarizing film; and
a support film disposed on at least one surface of the polarizing film, wherein the support film is pre-treated by a method of pre-treating a support film, comprising:
performing saponification on the support film in a solution of a strong alkali at 40 to 70° C.;
placing the support film in a solution of a silicate or a derivative thereof at 10 to 90° C. to react and form a silicon-oxygen bonding on a surface of the support film; and
removing the solvent in the solution on the support film.

15. The polarizing sheet as claimed in claim 14, further comprising a layer of an adhesive composition formed between the support film and the polarizing film, the adhesive composition comprising:
from 50 to 99 weight parts of an aqueous solvent;
from 0.5 to 10 weight parts of a polyvinyl alcohol; and
from 0.01 to 2 weight parts of R¹Si(OR²)₃ and a derivative thereof, wherein R¹ is a hydrocarbonyl group having a cross-linking functional group and R²s are same or different and each is a hydrogen atom or a hydrocarbonyl group.

16. The polarizing sheet as claimed in claim 14, wherein the polarizing film comprises an iodine-type polarizing film or a dichroic dye polarizing film.
